(19) United States
(12) Patent Application Publication
(10) Pub. No.: US 2009/0055336 A1
(43) Pub. Date: Feb. 26, 2009

(54) SYSTEM AND METHOD FOR CLASSIFYING MULTIMEDIA DATA

(75) Inventor: MENG-CHUN CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/124,165

(22) Filed: May 21, 2008

(30) Foreign Application Priority Data
Aug. 24, 2007 (CN) 200710201462.X

(51) Int. Cl. G06N 3/02

(52) U.S. Cl. 706/20

(57) ABSTRACT

A system for classifying multimedia data is provided. The system comprises a characteristic extracting unit configured for obtaining the multimedia data from the mobile apparatus, and extracting characteristics of multimedia data by using the MPEG-7; and a neural network model configured for predefining a training model, and classifying the multimedia data by classifying the characteristics according to the predefined training model. A related method is also provided.

### BACKGROUND

1. Field of the Invention

The present invention relates to a system and method for classification of multimedia data.

2. Description of related art

These days, most mobile phones are equipped with a dedicated multimedia processor or include various multimedia functions. Mobile phones offer more and more advanced multimedia capabilities, such as image capturing and digital broadcast receiving. As a result, in support of these multimedia functions, hardware configurations and application procedures have become more complicated. During using the mobile phones, there are more and more multimedia data downloaded from the Internet or an intranet. For example, a user who likes music, he/she may download many songs into the mobile phone. However, if there are too many songs in the mobile phone, it becomes difficult to organize them and quickly access them.

Accordingly, what is needed is a system and method for classifying multimedia data, which can classify the multimedia data allowing quick access to a user.

### SUMMARY

A system for classifying multimedia data is provided. The system comprises a characteristic extracting unit configured for obtaining the multimedia data from the mobile apparatus, and extracting characteristics of the multimedia data by using the MPEG-7; and a neural network model configured for predefining a training model, and classifying the multimedia data by classifying the characteristics according to the training model. A computer-based method for classifying multimedia data is also provided.

Other objects, advantages and novel features of the embodiments will be drawn from the following detailed description together with the attached drawings.

### BRIEF DESCRIPTION OF THE DRAWINGS

FIG. 1 is a schematic diagram of an application environment of a system for classifying multimedia data in accordance with an exemplary embodiment;

FIG. 2 is a block diagram of main function units of the system of FIG. 1

FIG. 3 is a flow chart of a method for classifying multimedia data;

FIG. 4 is a flow chart of a method of training a neural network model;

FIG. 5 is a schematic diagram of MPEG-7 audio data; and

FIGS. 6 and 7 are exemplary examples of a training model of the neural network model.

### DETAILED DESCRIPTION OF THE EMBODIMENTS

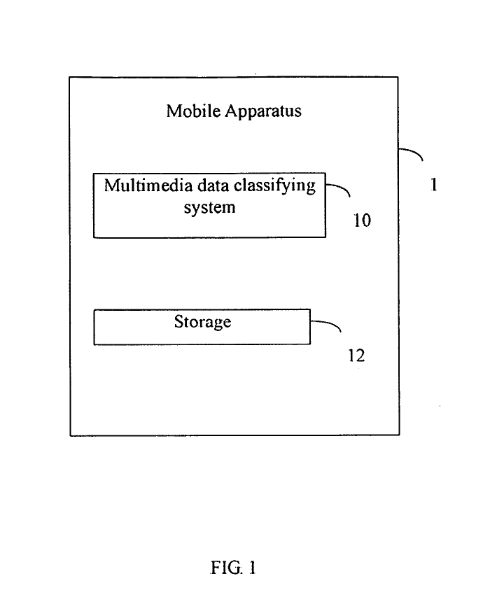

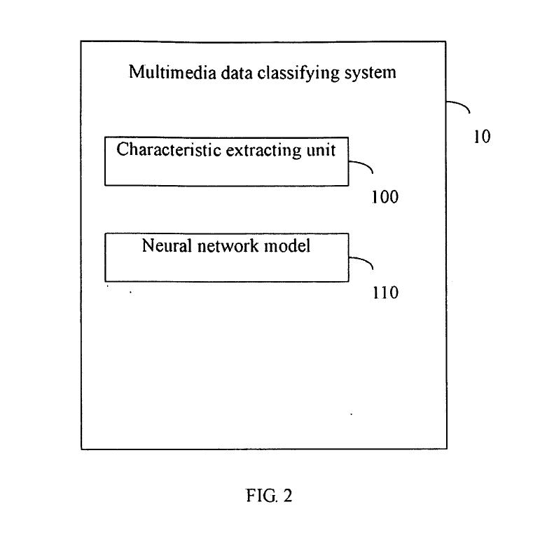

FIG. 1 is an application environment of a multimedia data classifying system 10 (hereinafter, “the system 10”) in accordance with a preferred embodiment. The system runs in a mobile apparatus 1. The mobile apparatus 1 may be a mobile phone, personal digital assistant (PDA), MP3 or any other suitable mobile apparatus. The system 10 is configured for obtaining the multimedia data from the mobile apparatus 1, extracting characteristics of the multimedia data by using the MPEG-7, classifying the multimedia data by classifying the extracted characteristics via a predefined training model. Generally, before shipment of the mobile apparatus 1, the neural network unit 110 (shown in FIG. 2) is trained according to the predefined training model. The moving pictures expert group (MPEG) is a working group under the international standards organization/international electro technical commission in charge of the development of international standards for compression, decompression, processing and coded representation of video data, audio data and their combination. MPEG previously developed the MPEG-1, MPEG-2 and MPEG-4 standards, and developed the MPEG-7 standard, which is formally called “multimedia content description interface”. MPEG-7 is a content representation standard for multimedia data search and includes techniques for describing individual media content and their combination. Thus, the goal of the MPEG-7 standard is to provide a set of standardized tools to describe the multimedia content. Thus, the MPEG-7 standard, unlike the MPEG-1, MPEG-2 or MPEG-4 standards, is not a media-content coding or compression standard but rather a standard for representation of descriptions of media content.

The mobile apparatus 1 further includes a storage 12 for storing various kinds of data used or generated by the system 10, such as multimedia data obtained from the mobile apparatus 1, classified multimedia data, and so on. The storage 12 may be an internal memory card or an external memory card. The external memory card typically includes a smart media card (SMC), a secure digital card (SDC), a compact flash card (CFC), a multi media card (MMC), a memory stick (MS), a extreme digital card (XDC), and a trans flash card (TFC).

FIG. 2 is a block diagram of the system 10. The system 10 includes a characteristic extracting unit 100 and a neural network model 110.

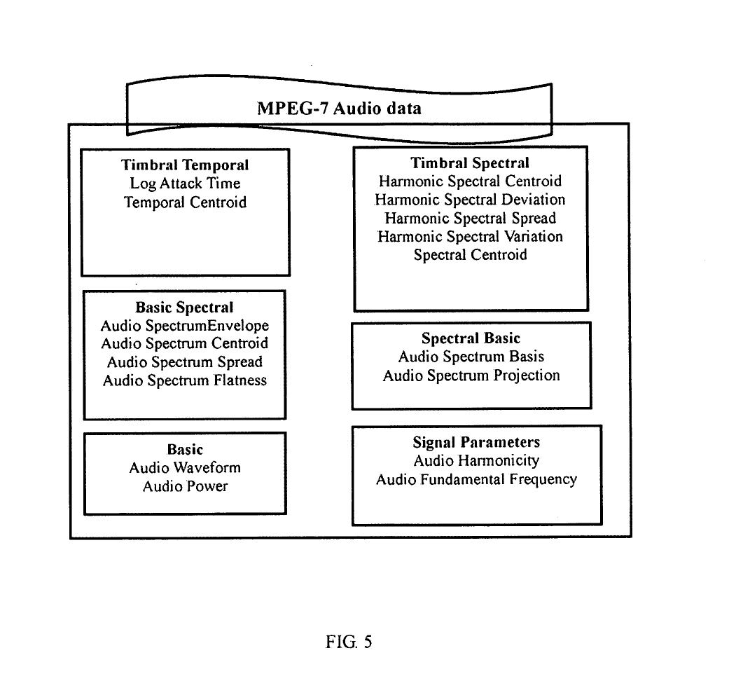

The characteristic extracting unit 100 is configured for obtaining the multimedia data from the mobile apparatus 1, and extracting characteristics of the multimedia data by using the MPEG-7. In order to describe conveniently, the multimedia data are regarded as audio data in the embodiment. MPEG-7 provides 17 modes about how to represent descriptions of audio content. The modes are classified into six clusters as follows: timbral temporal, timbral spectral, basic spectral, basic, signal parameters, and spectral basis (as shown in FIG. 5). The cluster of timbral temporal includes two characteristics, which are log attack time (LAT) and temporal centroid (TC). The characteristics of the LAT and the TC are obtained according to the following formulas:

LAT=log₁₀(T₁−T₀),

wherein T₀ is a time when signal starts and T₁ is a time when the signal reaches its maximum;

$$T C = \frac{{\sum }_{n = 1}^{length ( S E )} \frac{n}{S R} \cdot S E ( n )}{{\sum }_{n = 1}^{length ( S E )} S E ( n )} ,$$

wherein SE(n) is the signal envelope at times n calculated using the Hilbert Transform, and SR is a sampling rate.

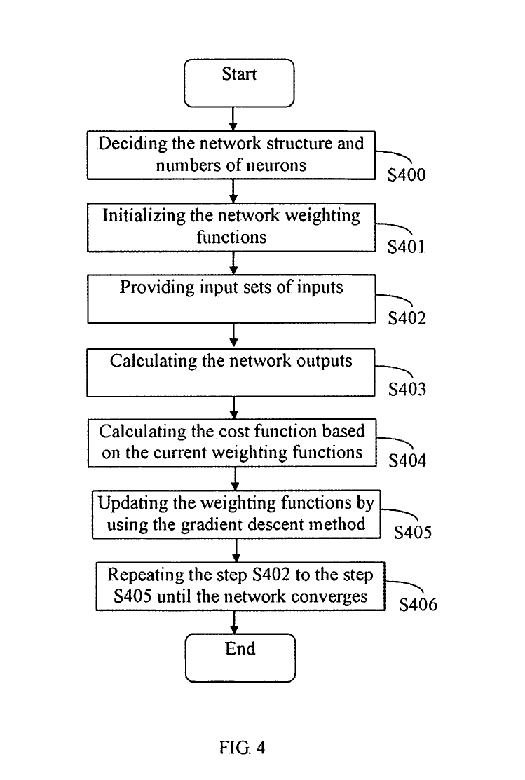

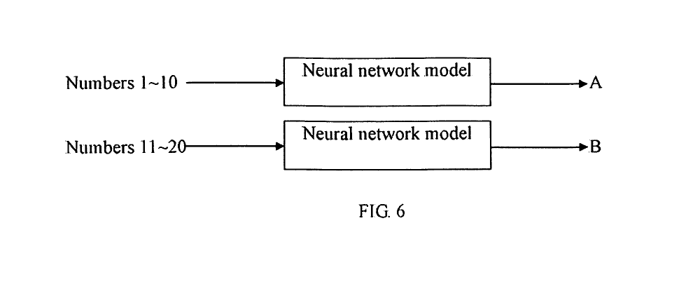

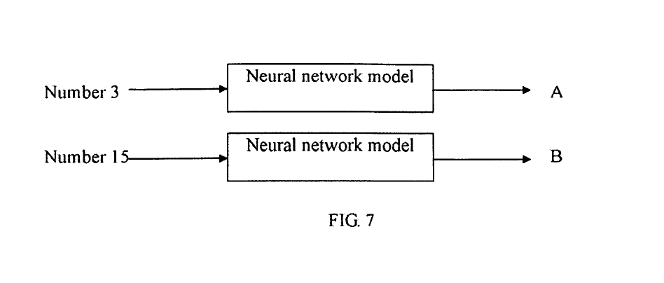

The neural network model 110 is configured for predefining a training model, classifying the audio data by classifying the characteristics according to the predefined training model. The training model is predefined according to users' demands. The training model may be realized according to the steps shown in FIG. 4. When the predefined training model receives an input value (i.e., the audio data), the predefined training model automatically outputs predefined results (i.e., the classified audio data). That is, the predefined training model classifies the input values according to the predefined training model. For example, in FIG. 6, if the input values are numbers between 1˜10, the predefined training model outputs “A”, and if the input values are numbers between 11˜20, the neural network model 110 outputs “B”. Then in FIG. 7, when the input value is “3”, the predefined training model outputs “A”. That is, the predefined training model classifies the input value “3” to be in category “A”. Meanwhile, if the input value is “15”, then the predefined training model outputs “B”. That is, the predefined training model classifies the input value “15” to be in category “B”.

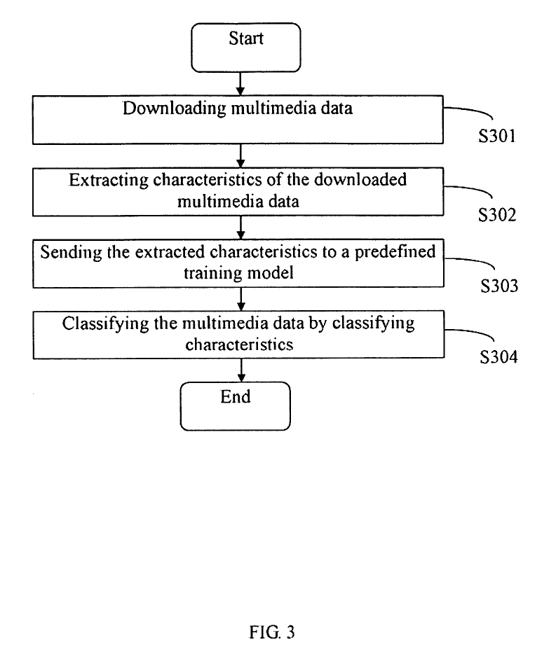

FIG. 3 is a flow chart of a preferred method for classifying multimedia data. In order to describe conveniently, the multimedia data is regard as the audio data. In step S301, a user downloads the audio data from Internet, Intranet, or any other suitable networks. In step S302, the characteristic extracting unit 100 extracts the characteristics of the downloaded audio data by using the MPEG-7 (as described in paragraph 17).

In step S303, after extracting the characteristics of the downloaded audio data, the characteristic extracting unit 100 sends the extracted characteristics to the neural network model 110. Before shipment of the mobile apparatus 1, the neural network model 110 is trained according to the predefined training model. The training steps are illustrated in FIG. 4.

In step S304, the neural network model 110 classifies the audio data by classifying the extracted characteristics according to the predefined training model.

FIG. 4 is a flow chart of a preferred method of training the neural network model 110. In step S400, the neural network model 110 decides a network structure and numbers of neurons. In step S401, the neural network model 110 initializes network weighting functions. In step S402, the neural network model 110 provides sets of inputs. In step S403, the neural network model 110 calculates network outputs. In step S404, the neural network model 110 calculates a cost function based on the current weighting functions. In step S405, the neural network model 110 updates the weighting functions by using a gradient descent method. And in step S406, repeating the steps from S402 to the step S405 until the neural network finishes converging.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for classifying multimedia data, the system running in a mobile apparatus, the system comprising:
a characteristic extracting unit configured for obtaining the multimedia data from the mobile apparatus, and extracting characteristics of the multimedia data by using the MPEG-7; and
a neural network model configured for predefining a training model, and classifying the multimedia data by classifying the characteristics according to the predefined training model.

2. The system according to claim 1, further comprising a storage for storing the classified multimedia data.

3. The system according to claim 1, wherein the mobile apparatus is a mobile phone, a PDA, or a MP3.

4. The system according to claim 1, wherein the multimedia data comprises video data, audio data and a combination of the video data and the audio data.

5. A computer-implemented method for classifying multimedia data the method comprising:
obtaining the multimedia data from a mobile apparatus;
extracting characteristics of the multimedia data by using the MPEG-7;
providing a neural network model for predefining a training model; and
classifying the multimedia data by classifying the characteristics according to the predefined training model.

6. The method according to claim 5, further comprising:
storing the classified multimedia data.

7. The method according to claim 5, wherein the multimedia data comprises video data, audio data and a combination of the video data and the audio data.
